(19) United States
(12) Patent Application Publication
(10) Pub. No.: US 2012/0080826 A1
(43) Pub. Date: Apr. 5, 2012

(54) RESIN COMPOSITION FOR NANOIMPRINT, AND METHOD FOR FORMING STRUCTURE

(75) Inventor: Yoshikazu Saito, Inagi-shi (JP)

(73) Assignee: CANON KABUSHIKI KAISHA, Tokyo (JP)

(21) Appl. No.: 13/377,135

(22) PCT Filed: May 13, 2010
(86) PCT No.: PCT/JP2010/003254

§ 371 Date: Dec. 8, 2011

(30) Foreign Application Priority Data
Jun. 17, 2009 (JP) 2009-144608

(51) Int. Cl. B29C 59/16; C09D 163/02

(52) U.S. Cl. 264/447; 522/170

(57) ABSTRACT

A resin composition for nanoimprint includes a cationically polymerizable compound that has crystalline characteristics and is solid at ordinary temperature, and a photo cationic polymerization initiator.

### TECHNICAL FIELD

The present invention relates to a photosensitive resin composition to be used for nanoimprint, and a method for forming a microstructure.

### BACKGROUND ART

In recent years, there has been proposed a technique called “nanoimprint”, which has been developed as a technique for manufacturing high-precision microstructures, such as semiconductor elements, microreactors, display elements, light emitting elements, ink jet recording heads, and microsensors. By this technique, a master mold (generally known as a mold) having a predetermined minute convexity-and-concavity pattern is pressed against a resin provided on a substrate, to transfer the pattern of the mold onto the resin.

Popular nanoimprint techniques include a thermal nanoimprint technique and an ultraviolet (UV) nanoimprint technique. By the thermal nanoimprint technique, a substrate having a thermoplastic resin provided thereon is heated and softened, and a mold is then pressed against the resin. In this manner, the pattern of the mold is transferred onto the resin. By the UV nanoimprint technique, on the other hand, ultraviolet rays are emitted onto a photosensitive resin provided on a substrate, with a mold being pressed against the photosensitive resin. After the photosensitive resin is hardened, the mold is removed. In this manner, the pattern of the mold is transferred onto the resin.

There is another technique developed by combining the thermal nanoimprint technique and the UV nanoimprint technique. By this technique, a photosensitive resin is softened by heating, and a mold is pressed against the photosensitive resin. Ultraviolet rays are then emitted onto the photosensitive resin, to harden the photosensitive resin. The mold is then removed. In this manner, the pattern of the mold is transferred onto the resin. It is difficult to transfer the pattern of a mold onto a photosensitive resin that is solid or has high viscosity at ordinary temperature. By this technique, however, the pattern can be readily transferred onto such a photosensitive resin at a low pressure in a short period of time by heating and softening the photosensitive resin. Accordingly, this nanoimprint technique can be advantageously applied to various kinds of photosensitive resins.

Japanese Patent Application Laid-Open No. 2008-142940 discusses a cationically polymerizable photosensitive resin composition that contains epoxy resin with a low softening temperature and is suitable for UV nanoimprint.

However, in the photosensitive resin composition discussed in Japanese Patent Application Laid-Open No. 2008-142940, the epoxy resin that is the main component has a low softening temperature. Therefore, when the photosensitive resin composition is applied to a substrate, the surface of the applied resin composition cannot be in the dry state, and foreign matters and the likes might often adhere to the surface. Such foreign matters adhering to the resin composition cannot be easily removed. As a result, the shape of the transferred pattern might be adversely affected.

Meanwhile, when nanoimprint patterning is performed on a monomer and/or a prepolymer that is solid at ordinary temperature, the resin is heated to the glass-transition temperature thereof or higher, and is softened accordingly. In the case of a monomer and/or a prepolymer that is used for conventional nanoimprint and is solid at ordinary temperature, the heating temperature or the applied pressure needs to be made higher, or each application time needs to be made longer, to achieve sufficient mold filling characteristics and a small residual film thickness. However, an increase in heating temperature or applied pressure might cause damage or deterioration of the substrate, the mold, or the mold release agent coating the mold surface. Also, a prolonged heating time or a prolonged pressure application time, of course, adds to the time required for the entire manufacturing process. To counter such issues, a monomer and/or a prepolymer that has a relatively low glass-transition temperature and is solid at ordinary temperature may be used. In that case, the viscosity can be easily lowered by heating, and the mold filling characteristics and the residual film thickness are improved. However, as the glass-transition temperature becomes closer to ordinary temperature, resins are likely to cause blocking, resulting in poor preservation stability in a solid state.

### SUMMARY OF INVENTION

The present invention is directed to a photosensitive resin composition that excels in preservation stability, and enables smooth formation of a pattern by a nanoimprint technique at a low pressure in a short period of time.

According to an aspect of the present invention, a resin composition for nanoimprint includes a cationically polymerizable compound that has crystalline characteristics and is solid at ordinary temperature, and a photo cationic polymerization initiator.

Each exemplary embodiment of the present invention can provide a photosensitive resin composition that excels in preservation stability, and enables smooth formation of a pattern by a nanoimprint technique at a low pressure in a short period of time.

Further features and aspects of the present invention will become apparent from the following detailed description of exemplary embodiments with reference to the attached drawings.

### BRIEF DESCRIPTION OF DRAWINGS

The accompanying drawings, which are incorporated in and constitute a part of the specification, illustrate exemplary embodiments, features, and aspects of the invention and, together with the description, serve to explain the principles of the invention.

[FIG. 1A]

FIG. 1A is a schematic cross-sectional view illustrating an example of a method for manufacturing a microstructure according to an exemplary embodiment of the present invention.

[FIG. 1B]

FIG. 1B is a schematic cross-sectional view illustrating an example of the method for manufacturing a microstructure according to the exemplary embodiment of the present invention.

[FIG. 1C]

FIG. 1C is a schematic cross-sectional view illustrating an example of the method for manufacturing a microstructure according to the exemplary embodiment of the present invention.

[FIG. 1D]

FIG. 1D is a schematic cross-sectional view illustrating an example of the method for manufacturing a microstructure according to the exemplary embodiment of the present invention.

[FIG. 1E]

FIG. 1E is a schematic cross-sectional view illustrating an example of the method for manufacturing a microstructure according to the exemplary embodiment of the present invention.

[FIG. 2A]

FIG. 2A is a schematic cross-sectional views illustrating an example of a method for manufacturing a microstructure according to an exemplary embodiment of the present invention.

[FIG. 2B]

FIG. 2B is a schematic cross-sectional views illustrating an example of the method for manufacturing a microstructure according to the exemplary embodiment of the present invention.

[FIG. 2C]

FIG. 2C is a schematic cross-sectional views illustrating an example of the method for manufacturing a microstructure according to the exemplary embodiment of the present invention.

[FIG. 2D]

FIG. 2D is a schematic cross-sectional views illustrating an example of the method for manufacturing a microstructure according to the exemplary embodiment of the present invention.

[FIG. 2E]

FIG. 2E is a schematic cross-sectional views illustrating an example of the method for manufacturing a microstructure according to the exemplary embodiment of the present invention.

[FIG. 2F]

FIG. 2F is a schematic cross-sectional views illustrating an example of the method for manufacturing a microstructure according to the exemplary embodiment of the present invention.

[FIG. 2G]

FIG. 2G is a schematic cross-sectional views illustrating an example of the method for manufacturing a microstructure according to the exemplary embodiment of the present invention.

[

FIG. 2H]

FIG. 2H is a schematic cross-sectional views illustrating an example of the method for manufacturing a microstructure according to the exemplary embodiment of the present invention.

[FIG. 3A]

FIG. 3A is a perspective view illustrating a method for manufacturing a liquid discharge head according to an exemplary embodiment of the present invention.

[FIG. 3B]

FIG. 3B is a perspective view illustrating the method for manufacturing a liquid discharge head according to the exemplary embodiment of the present invention.

### DESCRIPTION OF EMBODIMENTS

Various exemplary embodiments, features, and aspects of the invention will be described in detail below with reference to the drawings.

First, a resin composition for nanoimprint according to an exemplary embodiment of the present invention is described.

The resin composition for nanoimprint according to the exemplary embodiment of the present invention contains a monomer and/or a prepolymer as a cationically polymerizable compound that has crystalline characteristics and is a solid substance at ordinary temperature, and a photo cationic polymerization initiator.

The crystalline and cationically polymerizable monomer and/or prepolymer exhibits a number of crystalline peaks through X-ray diffraction. The melting point is higher than ordinary temperature and has a sharp profile. At temperatures equal to or higher than the melting point, the monomer and/or prepolymer almost loses the interactions between molecules and has very low viscosity. Examples of crystalline and cationically polymerizable monomers and prepolymers include monomers and prepolymers each having an epoxy group, a vinyl ether group, or an oxetane group. However, the present invention is not limited to those examples.

An example of a preferred crystalline epoxy monomer or prepolymer is a compound that is expressed by formula (1).

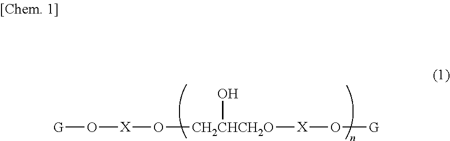

In formula (1), G represents a glycidyl group, n represents a number of 0 or larger, and X represents a group expressed by one of the following formulas (A), (B), and (C).

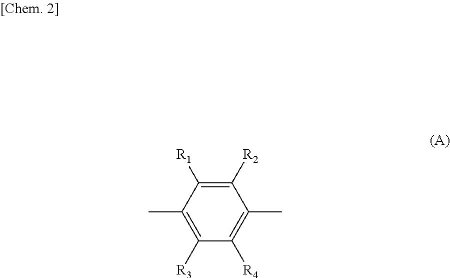

In formula (A), R₁ through R₄ each represent a hydrogen atom, a halogen atom, or an alkyl group of 1 to 6 in carbon number.

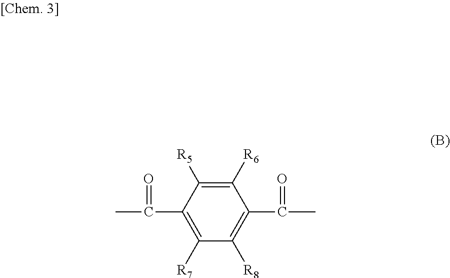

In formula (B), R₅ through R₈ each represent a hydrogen atom, a halogen atom, or an alkyl group of 1 to 6 in carbon number.

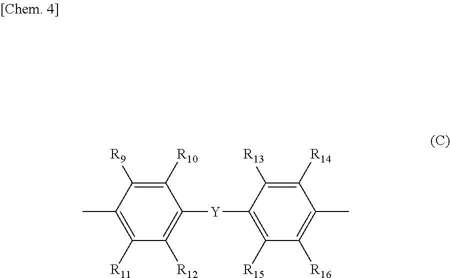

In formula (C), R₉ through R₁₆ each represent a hydrogen atom, a halogen atom, or an alkyl group of 1 to 6 in carbon number, and Y represents a group or a single bond that is selected from an oxygen atom, a sulfur atom, methylene, and formula (a).

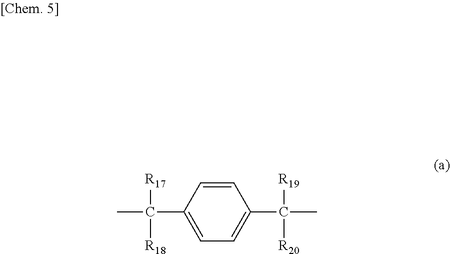

In formula (a), R₁₇ through R₂₀ each represent a hydrogen atom or a methyl group.

Examples of the names of compounds that can be expressed by formula (1) include 4,4′-dihydroxybiphenyl diglycidylether and 4,4′-dihydroxydiphenylether diglycidylether. The examples also include 3,3′,5,5′-tetramethyl-bisphenol F diglycidylether.

The examples further include 4,4′-dihydroxydiphenylsulfide diglycidylether, 1,4-bis(3-methyl-4-hydroxycumyl)benzene diglycidylether, and hydroquinone diglycidylether. Other than that, the examples include terephthalate diglycidylester.

It is also possible to use the epoxy resin discussed in Japanese Patent Application Laid-Open No. 8-092231, 2002-138130, 2002-338656, 2004-035762, or 2006-307011.

More specifically, it is possible to use YDC-1312, YSLV-50TE, YSLV-80XY, YSLV-80DE, YSLV-90CR, YSLV-120TE, GK-8001, or GK-4260 (trade names), which are manufactured by Tohto Kasei Co., Ltd. It is also possible to use DENACOL EX-203, DENACOL EX-711, or DENACOL EX-731 (trade names), which are manufactured by Nagase ChemteX Corporation, or YX4000 series, YL6121 series, YL6640, YL6643, or YL6677 (trade names), which are manufactured by Japan Epoxy Resins Co., Ltd. Any one of those monomers and prepolymers may be used independently of the others, or two or more of those monomers and prepolymers may be used in combination.

Those crystalline monomers and prepolymers can be handled as solid substances at ordinary temperature. The molecular weight of each of those monomers and prepolymers is approximately in the range of 300 to 3000 inclusive.

When a pattern is formed by nanoimprint, the viscosity becomes very low, since heating to the melting point or higher is performed. Accordingly, the blocking resistance at the time of preservation can be made higher, the pattern filling characteristics at the time of nanoimprint can be improved, and the residual film thickness can be reduced. Furthermore, any of those monomers and prepolymers is a solid substance at ordinary temperature. Accordingly, the issue of degradation of reactivity at the time of use due to development of a reaction over a long period of storage is hardly caused, and high preservation stability can be achieved. Cationically polymerizable compounds that can be used in the present invention are not limited to the above mentioned epoxy monomers and prepolymers, as long as they have crystalline characteristics and can maintain the above described properties.

There are no restrictions on photo cationic polymerization initiators, as long as those initiators are compounds that generate cation by virtue of activated energy rays. Preferred examples of the photo cationic polymerization initiators include aromatic diazonium salt, aromatic iodonium salt, aromatic sulfonium salt, and triazine. Specific examples of the photo cationic polymerization initiators include BBI-103 and BBI-102 (trade names), which are manufactured by Midori Kagaku Co., Ltd.

A sensitizer may also be added to improve the reactivity, as needed. Examples of sensitizers include anthracene derivatives, anthraquinone derivatives, xanthone derivatives, thioxanthone derivatives, perylene derivaties, and benzophenone derivatives.

Further, an additive agent such as an adhesiveness improver, an ion catcher, or inorganic filler may be added, where necessary, without departing from the scope of the invention.

In the case of a conventional photosensitive resin composition that is liquid at ordinary temperature, a uniform liquid might not be obtained unless the compounds constituting the photosensitive resin composition are combined, with the solubility of each compound being taken into consideration. In some cases, a segregation or separation might occur over a long storage period. On the other hand, there is no need to consider those issues with a photosensitive resin composition that is used in the present invention. Compounds having low solubility in solvents that have been difficult to use can also be used.

All the compounds that constitute the photosensitive resin composition preferably have a melting point between 50 degrees Celsius and 170 degrees Celsius. If a melting point is higher than that range, a very high temperature is required for nanoimprint processing. As a result, heavy loads are imposed on the nanoimprint apparatus, the mold, and the mold release agent.

Next, a method for forming a microstructure with the use of the resin composition for nanoimprint according to the above exemplary embodiment of the present invention is described, with reference to the accompanying drawings.

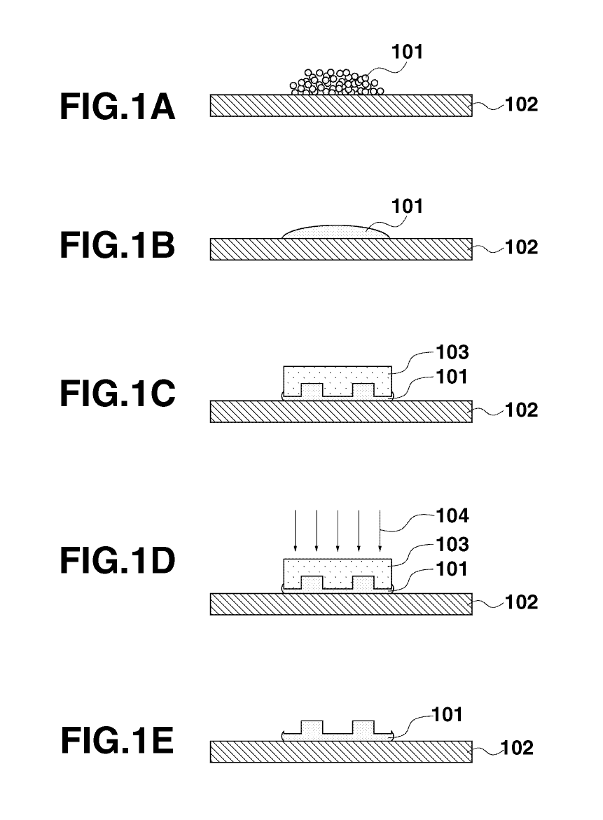

(1) The photosensitive resin composition 101 is prepared and placed on a substrate 102 (FIG. 1A).

The photosensitive resin composition 101 may be in a powdered state, or may be molded into a pellet. In a powdered state, the amount and position of the photosensitive resin composition 101 on the substrate 102 can be freely controlled according to the density and depth of the mold pattern to be transferred, and the filling efficiency and the pattern shape at the time of a pattern transfer can be improved. If the photosensitive resin composition 101 has a pellet-like form, on the other hand, it is easy to handle the photosensitive resin composition 101, and the amount of the photosensitive resin composition 101 to be placed on the substrate 102 does not need to be measured and controlled every time, as long as the usage amount is always the same. Therefore, a pellet-like form is also preferable.

Since the powder and the substrate are dry in this situation, adherence of foreign matters is smaller than in a case where a photosensitive resin composition that is liquid at ordinary temperature or a photosensitive resin composition having a low softening temperature is applied onto the substrate.

(2) The photosensitive resin composition 101 is then melted by heating (FIG. 1B).

Since the photosensitive resin composition 101 has crystalline characteristics, the photosensitive resin composition 101 turns into a liquid of very low viscosity and spreads over the substrate when heated to the melting temperature of the photosensitive resin composition 101 or higher. Also, since the photosensitive resin composition 101 does not contain a volatile compound such as a solvent or a reactive diluent, it is easy to handle the photosensitive resin composition 101, and the burden on the usage of the photosensitive resin composition 101 is reduced.

(3) The molding portion of a mold 103 as a master mold of a target structure having convex portions for transmitting activated energy rays is pressed against the photosensitive resin composition 101 (FIG. 1C). The width of the convex shape is approximately 1 to 20 micrometers at minute portions, and is approximately 50 to 200 micrometers at broader portions. The present invention is of course not limited to that.

While the surface of the mold 103 having the convex portions is pressed against the resin composition 101, the resin composition 101 is pushed over the enter pattern, to fill the gaps between the convex portions of the mold 103. The gaps between the convex portions form recessed portions, with the top ends or the middle portions of the convex portions being the reference points. Also, the pressure at which the mold 103 is pressed may be an appropriate value according to the physicality of the resin composition 101. For example, the pressure at which the mold 103 is pressed is 0.1 to 10 MPa. Further, those nanoimprint procedures may be carried out in a vacuum or under reduced pressure, so that air bubbles and the likes do not remain between the resin composition 101 and the mold 103.

The mold 103 for transmitting activated energy rays transmits at least part of the activated energy rays required for hardening the resin composition 101, and may be made of glass, quartz, resin, or the like. With mold durability being taken into consideration, a replica that is copied from a mold may be used as the mold 103.

Alternatively, a mold that is sufficiently heated in advance may be pressed against the photosensitive resin composition 101, and pressing may be performed while the photosensitive resin composition 101 is being melted. In this manner, the procedures (2) and (3) can be simplified.

(4) Activated energy rays 104 are then emitted onto the photosensitive resin composition 101 so that the photosensitive resin composition 101 is hardened. In this manner, a hardened material is obtained (FIG. 1D).

There are no particular restrictions on the activated energy rays 104, as long as the activated energy rays 104 can harden the resin composition 101. Examples of the activated energy rays 104 include ultraviolet rays, visible rays, infrared rays, X-rays, and gamma rays. Among those examples, ultraviolet rays can be used. Since the resin composition 101 is heated, the hardening reaction is facilitated in this case, compared with a hardening reaction caused by exposure at ordinary temperature. After the emission of the activated energy rays 104, the heated state may be maintained to further facilitate the hardening reaction.

(5) The mold 103 is then removed from the photosensitive resin composition 101 (FIG. 1E).

The mold 103 is removed by peeling, melting, dissolving, or the like. Peeling is particularly preferable, since peeling can be performed more than once. To prevent part of the resin composition 101 from adhering to the mold 103, a mold releasing operation may be performed by applying a mold release agent to the mold 103, for example. Examples of mold release agents that can be used here include
1H,1H,2H,2H-perfluorooctyltrichlorosilane,
1H,1H,2H,2H-perfluorodecyltrichlorosilane, and
1H,1H,2H,2H-perfluorododecyltrichlorosilane. The examples also include 1H,1H,2H,2H-perfluorooctyltrimethoxysilane,
1H,1H,2H,2H-perfluorodecyltrimethoxysilane, and
1H,1H,2H,2H-perfulrododecylmethoxysilane. The examples further include 1H,1H,2H,2H-perfluorooctyltriethoxysilane,
1H,1H,2H,2H-perfluorodecyltriethoxysilane, and
1H,1H,2H,2H-perfulrododecylethoxysilane. Other than the above, the examples include OPTOOL (trade name) series (manufactured by Daikin Industries, Ltd.), Novec EGC-1720 (trade name, manufactured by Sumitomo 3M Ltd.), NANOS (trade name) series (manufactured by T & K Inc.), and diamond-like carbon (DLC). The mold releasing operation can be performed by any preferred technique, such as dipping, spin coating, slit coating, spray coating, or vapor deposition, depending on the type of the used mold release agent.

A microstructure can be obtained in the above manner. The method for manufacturing a microstructure according to the present invention is suitable in manufacturing semiconductor elements, microfluidic chips, display elements, ink jet recording heads, microsensors, and the likes.

The mold as the master mold may not be removed, and the master mold having an epoxy coating formed thereon may be used as a component in the above mentioned fields.

### EXAMPLE 1

Each of the solid-state compounds shown in Table 1 was pulverized in an agate mortar, and a photosensitive resin composition was formed with the mixed powder obtained there.

TABLE 1

| | | | | |
|---|---|---|---|---|
| Epoxy resin | YSLV-80XY (trade name) | Tohto Kasei | 100 | parts by weight |
| | (3,3′,5,5′-tetramethylbisphenol | Co., Ltd. | | |
| | F epoxy resin), almost 368 in | | | |
| | molecular weight | | | |
| photo- | Rhodorsil Photoinitiator 2074 | Rhodia Inc. | 3 | parts by weight |
| polymerization | (trade name) | | | |
| initiator | | | | |
| Sensitizer | Kayacure DETX-S (trade name) | Nippon Kayaku | 1 | part by weight |
| | | Co., Ltd. | | |

A mold releasing operation was performed as follows. A quartz mold for nanoimprint, NIM-PH3000 (trade name, manufactured by NTT-AT Nanofabrication Corporation), was dipped in a mold release agent, DURASURF HD-1101TH (trade name, manufactured by HARVES Co., Ltd.). After left at room temperature for 24 hours, the mold was rinsed with Novec HFE-7100 (trade name, manufactured by Sumitomo 3M Ltd.), to remove the excess portion of the mold release agent.

The powder (20 mg) of the resin composition was then placed on a 4-inch silicon substrate. The silicon substrate was then heated to 130 degrees Celsius in a nanoimprint apparatus, LTNIP-2000 (trade name, manufactured by Litho Tech Japan Corporation), to melt the resin composition. With the quartz mold, pressing was performed on the resin composition at a pressure of 3.5 MPa. After the pressing was continued for 15 seconds, ultraviolet rays were emitted on the resin composition, with the exposure amount being 1000 mJ/cm². The quartz mold was then released, and the substrate was cooled to ordinary temperature. In this manner, a microstructure pattern was obtained.

The exterior and sections of the formed pattern were observed with a scanning electron microscope, to examine the shape of the pattern and the residual film thickness. As a result, no concavities were found in the pattern, and the average residual film thickness was 17 nm.

The powder of the photosensitive resin composition was stored at ordinary temperature for one month, and was then observed visually. As a result, no change is found in the exterior of the powder.

### COMPARATIVE EXAMPLE 1

Each of the solid-state compounds shown in Table 2 was pulverized in an agate mortar, and a photosensitive resin composition was formed with the mixed and adjusted particles obtained there. Other than that, nanoimprint was performed in the same manner as in Example 1.

TABLE 2

| | | | | |
|---|---|---|---|---|
| Epoxy resin | 157S70 (trade name) | Japan Epoxy | 100 | parts by weight |
| | (bisphenol A novolac-type | Resins Co., | | |
| | epoxy resin) | Ltd. | | |
| Photo- | Rhodorsil Photoinitiator 2074 | Rhodia Inc. | 3 | parts by weight |
| polymerization | (trade name) | | | |
| initiator | | | | |
| Sensitizer | Kayacure DETX-S (trade name) | Nippon Kayaku | 1 | part by weight |
| | | Co., Ltd. | | |

The exterior and sections of the formed pattern were observed with a scanning electron microscope, to examine the shape of the pattern and the residual film thickness. As a result, no concavitie is found in the pattern, and the average residual film thickness was 233 nm.

The powder of the photosensitive resin composition was stored at ordinary temperature for one month, and was then observed visually. As a result, blocking was seen, and the powder was firmly fixed.

### EXAMPLE 2

### Manufacture of a Thermal Ink Jet Recording Head

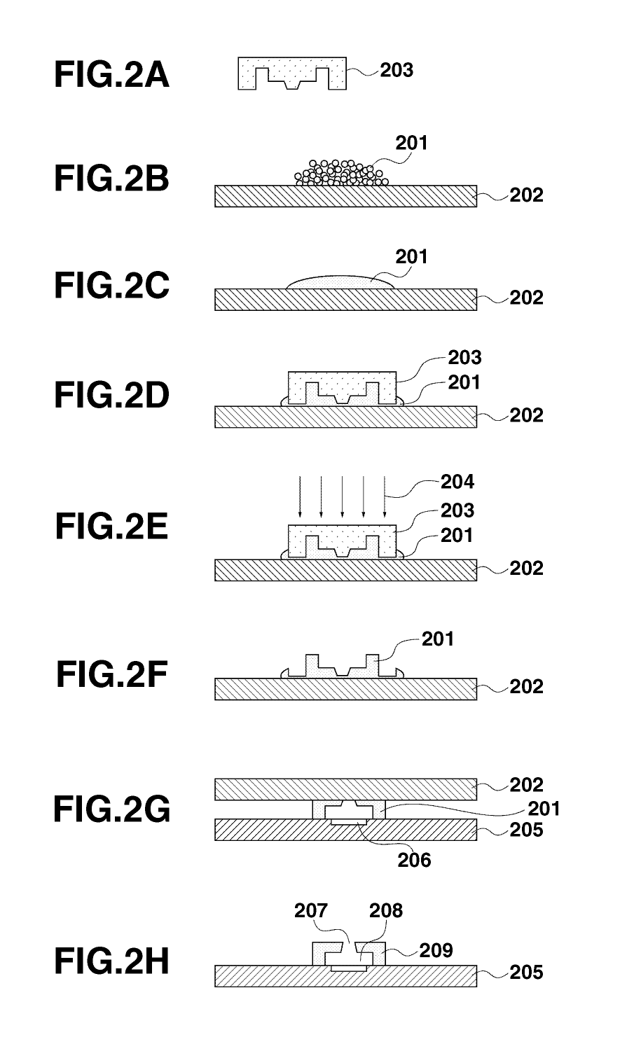

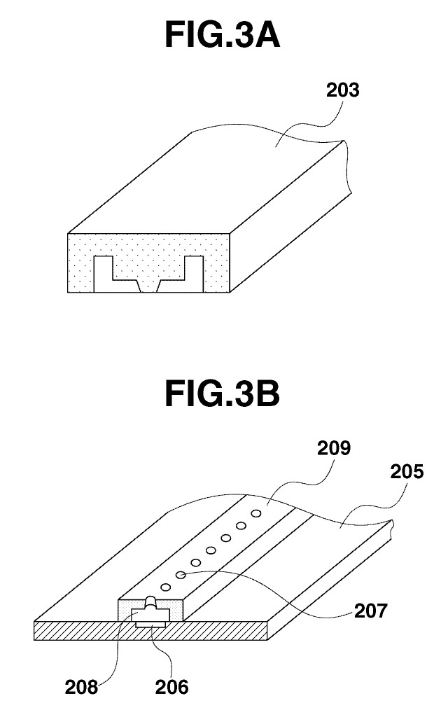

First, a quartz mold 203 that had a pattern of ink discharge ports for discharging ink droplets and ink flow passages for supplying ink to the ink discharge ports was prepared (FIG. 2A). A mold releasing operation was performed as follows. The quartz mold 203 was dipped in a mold release agent, DURASURF HD-1101TH (trade name, manufactured by HARVES Co., Ltd.). After left at room temperature for 24 hours, the mold 203 was rinsed with Novec HFE-7100 (trade name, manufactured by Sumitomo 3M Ltd.), to remove the excess portion of the mold release agent. The mold 203 was three-dimensionally formed in conformity to the shape of a head, as illustrated in a perspective view illustrated FIG. 3A.

Each of the compounds shown in Table 1 was pulverized, and 25 mg of mixed power 201 was placed on a 4-inch silicon substrate 202 (FIG. 2B). The silicon substrate 202 was then heated to 130 degrees Celsius in a nanoimprint apparatus, LTNIP-2000 (trade name, manufactured by Litho Tech Japan Corporation), to melt the photosensitive resin composition 201 (FIG. 2C). With the quartz mold 203, pressing was performed on the resin composition 201 at a pressure of 3.5 MPa (FIG. 2D). After the pressing was continued for 15 seconds, ultraviolet rays were emitted on the resin composition 201, with the exposure amount being 1000 mJ/cm² (FIG. 2E). The quartz mold 203 was then released, and the substrate was cooled to ordinary temperature. In this manner, the resin composition 201 having the ink discharge ports and the ink flow passages was obtained (FIG. 2F).

Etching was then performed on the resin composition 201 by reactive ion etching (RIE) with oxygen, to remove the residual film. Further, the resin composition 201 was bonded to a silicon substrate 205 that had electric heat conversion elements 206 as energy generating elements that generated the energy for discharging ink, and ink supply ports (not illustrated) for supplying ink (FIG. 2G).

The silicon substrate 205 supporting the resin composition 201 was then removed, and a thermal ink jet recording heat was completed (FIG. 2H). As illustrated in FIG. 3B, the molding portions of the mold turn into passages 208 and discharge ports 207, forming a flow passage forming member 209. The discharge ports 207 are arranged in a predetermined direction, and the energy generating elements 206 are provided in conformity to the arrangement of the discharge ports 207.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-144608 filed Jun. 17, 2009, which is hereby incorporated by reference herein in its entirety.

1. A resin composition for nanoimprint, comprising:
a cationically polymerizable compound that has crystalline characteristics and is solid at ordinary temperature; and
a photo cationic polymerization initiator.

2. The resin composition for nanoimprint according to claim 1, further comprising a sensitizer for the photo cationic polymerization initiator.

3. The resin composition for nanoimprint according to claim 1, wherein a melting point of the cationically polymerizable compound and a melting point of the photo cationic polymerization initiator are in the range of 50 to 170 degrees Celsius inclusive.

4. The resin composition for nanoimprint according to claim 1, wherein the cationically polymerizable compound is expressed by formula (1) 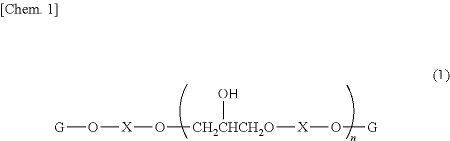
where G represents a glycidyl group, n represents a number of 0 or larger, and X represents a group expressed by one of the following formulas (A), (B), and (C), 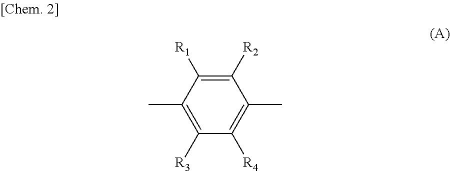
where R₁ through R₄ each represent a hydrogen atom, a halogen atom, or an alkyl group of 1 to 6 in carbon number, 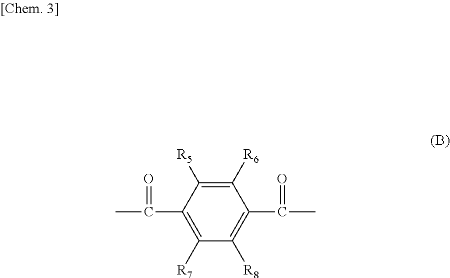
where R₅ through R₈ each represent a hydrogen atom, a halogen atom, or an alkyl group of 1 to 6 in carbon number, 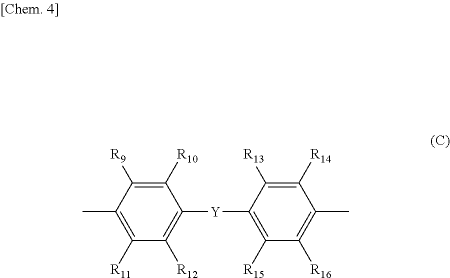
where R₉ through R₁₆ each represent a hydrogen atom, a halogen atom, or an alkyl group of 1 to 6 in carbon number, and Y represents a group or a single bond that is selected from an oxygen atom, a sulfur atom, methylene, and formula (a), 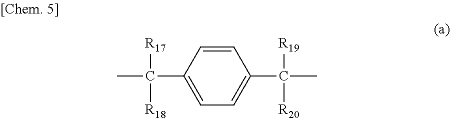
where R₁₇ through R₂₀ each represent a hydrogen atom or a methyl group.

5. The resin composition for nanoimprint according to claim 1, wherein the cationically polymerizable compound is in a powdered state.

6. The resin composition for nanoimprint according to claim 1, wherein the cationically polymerizable compound has a molecular weight of 300 to 3000 inclusive.

7. A method for manufacturing a structure, the method comprising:
providing the resin composition according to claim 1 on a substrate;
melting the resin composition by heating the resin composition;
pressing a molding portion of a master mold against the melted resin composition; and
forming a microstructure by emitting light onto the resin composition against which the molding portion is pressed, and hardening the resin composition.

8. A method for manufacturing a structure, the method comprising:
providing the resin composition according to claim 1 on a substrate;
melting the resin composition by pressing a molding portion of a master mold against the resin composition, the master mold being heated to a melting temperature of the resin composition or higher; and
forming a microstructure by emitting light onto the resin composition against which the molding portion is pressed, and hardening the resin composition.

9. The method according to claim 7, further comprising
removing the master mold from a hardened product obtained by hardening the resin composition.
